(19) United States
(12) Patent Application Publication
(10) Pub. No.: US 2005/0155498 A1
(43) Pub. Date: Jul. 21, 2005

(54) Transportable cooking and smoking barbeque

(76) Inventor: Ronald B. Killion, Anderson, IN (US)

Correspondence Address: RITCHISON LAW OFFICES, PC;John D. Ritchison, Suite A, 115 East Ninth Street, Anderson, IN, 46016-1509, US

(21) Appl. No.: 11/036,665

(22) Filed: Jan. 14, 2005

Related U.S. Application Data
(60) Provisional application No. 60/536,743, filed on Jan. 15, 2004.

(51) Int. Cl. A23L 1/00

(52) U.S. Cl. 99/482

(57) ABSTRACT

The IMPROVED and TRANSPORTABLE COOKING AND SMOKING BARBEQUE APPARATUS is an apparatus that is often called a Smoker. The device may be utilized as a stand alone Smoker to cook and smoke various foods such as meat and fish, fruits and vegetables. The device may be freestanding or on a portable set of wheels or trailer. The main components of this invention are comprised of a cooking chamber with a food rotisserie, a firebox, a draft system for controlling the air, and various options to enhance the convenience of the device. These main components have additional features to improve the start-up time to attain the temperature desired and sealing features which permit the smoke and heat to be well controlled.

### CROSS-REFERENCE TO RELATED APPLICATIONS

This application claims the benefit of Provisional Patent Application Ser. No. 60/536,743 filed Jan. 15, 2004 by Ronald B. Killion and titled “IMPROVED and TRANSPORTABLE COOKING AND SMOKING BARBEQUE APPARATUS”.

### FIELD OF INVENTION

The present invention relates generally to an Improved and Transportable Cooking and Smoking Barbeque Apparatus that is often called a Smoker. The device may be utilized as a stand alone Smoker to cook and smoke various foods such as meat and fish, fruits and vegetables. The device may be freestanding or on a portable set of wheels or trailer. The same technology shown below may be configured in various sizes. In addition, the various sizes lend themselves to individual use as well as commercial use for concessions, catering and restaurants.

The new Smoker device is made of standard materials and has features to improve the efficiency, durability, and versatility of Smokers for cooking and smoking in the barbeque industry. The various improvements will be discussed below. Other prior art does not suggest or disclose the features of the present invention.

### FEDERALLY SPONSORED RESEARCH

Not Applicable.

### SEQUENCE LISTING OR PROGRAM

Not Applicable.

### BACKGROUND—FIELD OF INVENTION

The science of cooking and food preparation has progressed considerably from those first days of open fire cooking. Notwithstanding this progress, the flavors produced in various types of food products from being cooked over an open flame still enjoy considerable public demand. In addition, barbecued foods have experienced a recent upsurge in public demand as a menu item for large outdoor activities such as parties, reunions and similar social activities. Obviously, the provision of open cooking fires for large gatherings creates a considerable number of difficulties. One conventional class of barbecue devices provides a heating compartment which raises air to a temperature effective for convective cooking of foods located in an adjacent compartment. The adjacent cooking compartment may be located vertically or laterally of the heating compartment. All of the heated air generally passes over the food and exits through a stack having a damper for regulating the output air flow. The present device is directly related to those types of barbeque smokers for cooking and enhancing the flavors of meats, fruits, vegetables and other foods.

A. Introduction of the Problems Addressed

Barbeque smokers have in the past been plagued with various shortfalls. These include, but are not limited to, slow start-ups to arrive at cooking temperatures, difficult temperature control, frequent attendance to heat sources, cumbersome means to load and unload the food into the cooking chamber, untenable portability, and unstable rotisserie devices that allow the loss of food into the cooking chamber.

B. Prior Art

Historically, the prior art devices to smoke and barbeque foods have addressed some of these needs, but never has any combination provided a solution in one device to virtually all these shortfalls.

Examples of prior devices for barbeque smokers of these types begin with U.S. Pat. No. 2,399,163 issued to Brunamonti (1946). This teaches a way to barbeque and smoke foods without a rotisserie, portability or the accurate control of airflow, temperature control and exhaust control. A decade later, another device reveals a rotisserie smoke and a patent was issued to Shyrack as a U.S. Pat. No. 2,790,380 (1957). This patent taught a rotisserie smoker with a non-integral heat source, no finishing grill, and virtual non-portability.

Other examples include a U.S. Pat. No. 3,683,791 issued to Rast (1972) which teaches and describes as a specific way to cook food on a flat, non-rotisserie grill with a fire directly under the food. No significant or accurate control of airflow, temperature control and exhaust control is taught. A U.S. Pat. No. 3,792,654 issued to Turner (1974) teaches a bottom fire, limited temperature and air flow control, a tip-able food tray, and a complex, non-robust drive system. A U.S. Pat. No. 4,700,618 issued to Cox (1987) teaches flat grill without any rotisserie features, a limited control of airflow, temperature control and exhaust control and an end box for the heat source.

Another outdoor barbeque device is shown in U.S. Pat. No. 4,757,756 issued to Van Marr (1988). This device uses some limited ventilation control, a bottom fire box, a complex ash removal system, and a shelf/finishing space. A U.S. Pat. No. 4,867,051 issued to Schalk (1989) was focused on a non-portable rotisserie smoker, small and limited in stature, limited ventilation and airflow control, and a bottom fire heating system.

The U.S. Pat. No. 4,882,985 issued to Beller (1989) teaches a non-portable smoker, a rotisserie device to contain a “rolled” meat, a bottom fire heating system, and limited control of airflow, temperature control and exhaust control. Another barbeque device by Beller, U.S. Pat. No. 5,195,423 is a small, stationary cooker/smoker with and end box heating system, a flat grill and very limited control of airflow, temperature control and exhaust control as compared to the IMPROVED BARBEQUE SMOKER DEVICE.

The U.S. Pat. No. 5,205,207 issued to McGuire (1993) teaches a tippable rotisserie tray, a bottom fire system, and a limited control of airflow, temperature control and exhaust control. Also, the access to the rotisserie device is somewhat limited as compared to the present invention.

The U.S. Pat. No. 5,515,774 issued to Swisher et al. (1996) teaches a bottom fire/heat system, limited control of airflow, temperature control and exhaust control, a pull-out re-load area for the charcoal, and basically a “pig-hog roasting” spit which may be extracted from the cooking chamber. The U.S. Pat. No. 6,138,553 issued to Toebben (2000) teaches a anon-portable system, limited control of airflow, temperature control and exhaust control, a bottom fire/heat system and tip-able rotisserie grill.

None of the above described prior art teaches all the features and capabilities of the MARITAL SUPPORT PLATFORM in respect to intercourse platform devices.

### SUMMARY OF THE INVENTION

This invention is an Improved and Transportable Cooking and Smoking Barbeque—called a SMOKER. The improvements are built in as features that will be described below. These features permit a Smoker to provide durability, efficiency and versatility unmatched in the current state of the barbeque industry.

The main components of this invention are comprised of a cooking chamber with a food rotisserie, a firebox, a draft system for controlling the air, and various options to enhance the convenience of the device. These main components are comprised of sub-components that are specified fully in the descriptions below and in the accompanying drawings. The preferred embodiment is a Smoker device in various sizes mounted on a portable trailer bed. An alternative embodiment uses the scope of the improvements but may be utilized as a freestanding, non-portable device to attain the improvements without the cost of the trailer system.

The materials comprising the device are standard and available from many sources. The materials are primarily the same as utilized in other barbeque and grilling machinery designs. However the present invention has a significantly improved configuration. One skilled in the art can appreciate the scope and spirit of this invention as described below and as depicted in the accompanying drawings.

### OBJECTS AND ADVANTAGES

Accordingly, there are several objects and advantages of the IMPROVED BARBEQUE SMOKER DEVICE. There currently exist only a few devices that address some of the problems and challenges in the barbeque smoker industry. These devices normally cost comparatively much more than this invention. Those devices also need many adjustments for proper use. Some of the adjustments require tools and special controls. This IMPROVED BARBEQUE SMOKER DEVICE because it is specifically designed to improve the majority of shortfalls in an economical and simple manner that the consumer may afford. The advantages that are provided here will be fully evident to one skilled in the art of smokers and barbeque cooking devices once the fully detailed description of the embodiment, the operation and the drawings are presented below.

One advantage of this device over others in the field is that it has a superior firebox and draft system. The fuel lies in a separate firebox that runs along the length of the cooking chamber. This provides consistent heat to the chamber. The baffle system controlling the air permits a very fast start and heat-up as well as adjustable temperature control for the device.

Further important advantages are related to the versatility over prior art:
a. The Present designed Smoker may be used on a portable trailer or as a freestanding device;
b. The device may be normally configured in sizes ranging from two to twelve feet long or other specially required sizes;
c. And, the device may have different fuels such as wood, charcoal, natural gas, LP gas, corn, or the like. These are exemplary and not limiting fuels.

Another advantage is the simple and inexpensive design of the improved smoker. The materials and components are commercially available in large quantities to provide economy of scale. The various size Smoker units used many of the same interchangeable sub-components such as the bearings, rotisserie drives, hinges and grill support, etc. The design has been specified to use standard manufacturing processes and easily assembled components. The other designs often have additional fasteners and different designs for different sized units.

Still another advantage is simplicity of use and ergonomic features. The draft control is at the food side, away from the firebox permitting the cook to add food and control the temperature without walking around to the back of the Smoker. The large access doors to the firebox permit fast reloading of wood and other fuel types. The recessed doors to the cooking chamber retain heat and smoke when adding food to the rotisserie in the cooking chamber. In addition, ash removal is facilitated with a removable tray running under the firebox.

Of further importance is the durability and quality of the present invention. The cooking chamber and firebox is comprised of high grade, thick steel plates. All components have long-life built in to the design. Each unit is burned in and checked for air seal and continuity of the joining between the chamber and firebox. Internal components are removable and interchangeable if any replacement is ever required.

Other important features are related to safety. The firebox is separated from the chamber eliminating hot embers and flare-ups of fire reaching the food. The rotisserie has a “no tip” pivot system that eliminates or greatly reduces the food carrying trays from sticking in a position and dumping the tray onto the trays below. The front door seal configuration keeps smoke contained and away from the cook/operator. And, optional fuel storage carrying boxes may be place away from the firebox.

The advantage of controlling the heat, smoke and air provide improved operating economics. The fast start and the consistent temperature control (through the draft system) reduce the amount of fuel needed to get the chamber to cooking temperature. This same control reduces the fuel additions required to keep the chamber at temperature during extended lengths of use. The industry has had a long felt need for better draft control and fuel addition capability for smoker units. The industry has also suffered lack of durability and short life of some units that lacked removable and replaceable components.

Other convenience improvements have been addressed with various options to add to the preferred embodiment. Finishing grills for adding sauces and other foods; warming boxes to prepare quantities for a quick, one-time serving; special roasting cages for special needs such as a “pig roast”; gas assist lighting devices; wash sinks; utility boxes and even beverage container such as keg-holders for beer; and the like.

Finally, other advantages and additional features of the present invention will be more apparent from the accompanying drawings and from the full description of the invention. For one skilled in the art of barbeque smoker devices, such as described here, it is readily understood that the features shown in the examples with this invention are readily adapted to other types of smoking and cooking devices.

### DESCRIPTION OF THE DRAWINGS

The accompanying drawings, which are incorporated in and constitute a part of this specification, illustrate an embodiment of the present invention that is preferred. The drawings together with the summary description given above and a detailed description given below serve to explain the principles of the invention. It is understood, however, that the invention is not limited to the precise arrangements and instrumentalities shown.

The drawings, sketches, and views include:

FIG. 1 is a Front View of the Present Invention.

FIG. 2 is a Front View of the Present Invention with Details of several components.

FIG. 3 is a Perspective View of the Front and Drive End of the Present Invention with Details of components.

FIG. 4 is a Perspective View of the Back and Drive End of the Present Invention with component details.

FIG. 5 is a Back View of the Present Invention with component details.

FIG. 6 is a Front Perspective View of a Six-Foot Smoker Unit, generally.

FIG. 7 is a Front Perspective View of a Smoker Unit with component details.

FIG. 8 is a Front and Freely Driven Perspective View of a Six-Foot Smoker Unit with component details.

FIG. 9 is a Drive End View of a Smoker Unit with component details.

FIG. 10 is a Front and Drive End Perspective View of a Smoker Unit with component details.

FIG. 11 is a Front Perspective View of a Freestanding Smoker Unit.

FIG. 12 is a Close Perspective View of a Firebox under construction with component details.

FIG. 13 is a Perspective View from the Freely Driven End and FIREBOX for a Smoker Unit with component details.

FIG. 14 is a Back Perspective View of a Firebox for a Smoker Unit with component details.

FIG. 15 is a Close View of the Baffle Adjustment Levers on the Front Side of a Smoker Unit with Details of the general components.

FIG. 16 is a Drive End Perspective View of the Baffle Adjustment Linkage System for a Smoker Unit.

FIG. 17 is a Close View of the Back Side Air Intake Cover and Air Diverting System.

FIG. 18 is a Back View of a Smoker and Firebox under construction.

FIG. 19 is a Front View of a Smoker and Cooking Chamber under construction.

FIG. 20 is a Close View of a Back of a Smoker Firebox under construction.

FIG. 21 is a Back Perspective View of a Smoker Firebox under construction.

FIG. 22 is a Cross-section Drawing of a Smoker with the Air Diverting System “Closed-off”.

FIG. 23 is a Cross-section drawing of a Smoker with the Air Diverting System “Opened Partly”.

FIG. 24 is a Cross-section drawing of a Smoker with the Air Diverting System “Opened full”.

FIG. 25 is a Front View of a Smoker Unit under construction showing the Food Holding and Rotisserie System in the Cooking Chamber.

FIG. 26 is a Close View of the Food Tray Mounting and Pivot System.

FIG. 27 is a View of the Trailer Structure under construction.

FIG. 28 is a View of a Side View of a Smoker Unit on a Trailer with several of the Optional Features for a Smoker System.

### REFERENCE NUMERALS

The following list refers to the drawings:
31 general smoker
32 food access doors
33 drive system
33 rotisserie drive
34 support system
35 ground or trailer bed
36 optional warming box
37 exhaust stack
38 front food tray
39 optional Finishing Grill
40 trailer trim
41 wheel spokes
42 firebox
43 air intake opening
44 latching/seal system
45 air control linkage
46 temperature control linkage
47 cooking chamber
48 firebox pivot or hinge system
49 door/cover latch
50 firebox door handle
51 a six (6) foot smoker unit
52 free-driven bearing system
53 fuel support system (grate)
54 end plates of the firebox
54A top plates of the firebox
55 special end plate
56 welded/sealed joint
57 ash tray
58 lever type
59 lever type
60 means to control the settings for the previously mentioned levers 58 and 59
61 individual food tray
62 food door aperture
63 air diverter
64 air intake openings into the firebox
65 rotisserie shaft/drive mechanism
66 support structure
66 spreader bars
67 rotisserie system pivot/mount system
67 cantilevered stub shaft
68 the openings from the fire box to the cooking chamber
69 front door seal configuration
69 intricate labyrinth
69 recessed area
70 temperature baffle
71 pivot system for the temperature control baffle
72 temperature control shaft
73 air intake shaft extension
74 main bearing system
75 rotisserie system
76 air intake baffle
77 fuel
78 linkage type
79 Linkage type
80 stack baffle
81 control mechanism which is a lever, handle or the like
82 “Closed-off” airflow
83 “Opened Partly” airflow
84 “Opened full” airflow
85 collet
86 wheel system
87 structural support
88 means to attach to a vehicle such a hitch or the like
89 front vertical support “jack”
90 tray strap

### DETAILED DESCRIPTION OF PREFERRED EMBODIMENT

The present invention is an Improved and Transportable Cooking and Smoking Barbeque Apparatus often called a Smoker. The improved Smoker device has various features to enhance its use. These features are built-in to the main body of the device.

The main components of this invention are comprised of:
a cooking chamber with a food rotisserie,
a firebox,
a draft system for controlling the air, and various options to enhance the convenience of the device.
   These main components are comprised of sub-components that are specified fully in the descriptions below and in the accompanying drawings.

The preferred embodiment is a Smoker device in various sizes mounted on a portable trailer bed. An alternative embodiment uses the scope of the improvements but may be utilized as a freestanding, non-portable device to attain the improvements without the cost of the trailer system.

The materials comprising the device are standard and available from many sources. The basic materials are primarily the same as utilized in other smokers. The enhanced components and interchangeable parts of the present invention have significantly improved configurations. A person having ordinary skill in the field of this invention appreciates the various materials and component parts that may be used to physically permit this improved cooking and smoker device to be produced and utilized. The improvements over the existing art are providing a smoker device that:
a. has a superior firebox and draft system;
b. is versatile over prior art in portability, varying sizes, and capability of using different fuels;
c. has a simple and inexpensive design;
d. is simple to use and ergonomically correct;
e. has extended durability and improved quality;
f. has several improved safety features;
g. provides better operating economics; and
h. extends other conveniences through various options

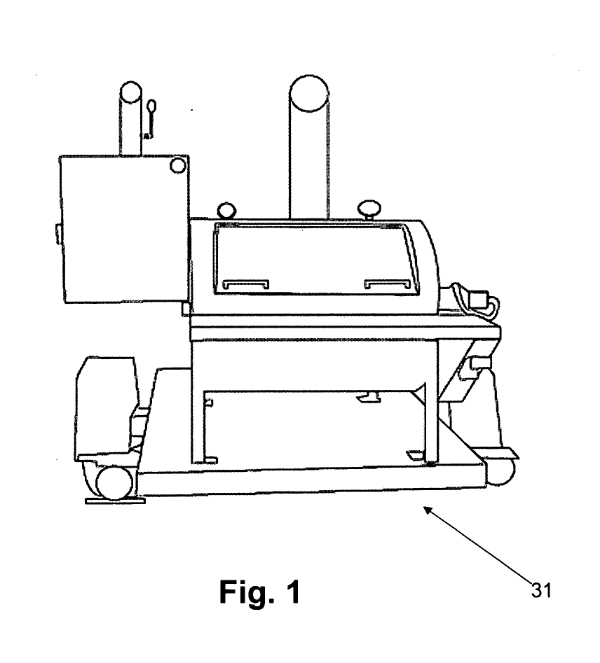

In the drawings and illustrations, one notes well that the FIGS. 1-28 demonstrate the general condition of an Improved Cooking and Smoker System. It consists of generally of the same design for all sizes. For simplicity it is understood that many times in the descriptions, below, only one size of a Smoker Unit system will be referenced.

The manner of the device described is functionally understood by those skilled in the art to be appropriate for various sized Smoker units. The descriptions and discussions below are primarily shown for the Three-foot and Six-foot long Smoker devices. One skilled in the art readily appreciates that various other sizes such as 2, 4, 5, 8, 10, 12 foot long and the like (as well as some possibly still being developed) can benefit from similar uses of the present invention. Therefore, the descriptions are exemplary and not limiting in their nature.

The preferred embodiment, alternative embodiments and drawings of the present invention are shown in FIG. 1-28 of the drawings.

FIG. 1 is a Front View of the Present Invention. This view shows the three (3) foot smoker 31.

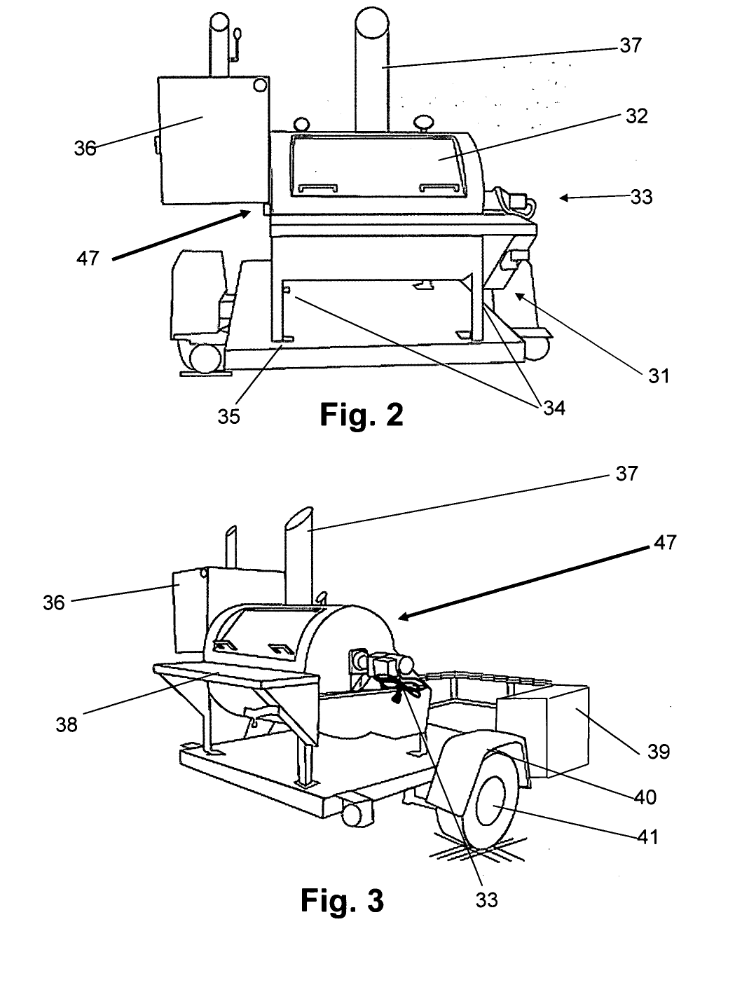

FIG. 2 is a Front View of the Present Invention with Details of several components. The general smoker 31 is depicted. The support system 34 shows a means of support. The number of legs—3, 4, 5, or the like are immaterial since the important function of the support system 34 is to raise the smoker system 31 above the ground or trailer bed 35 to a level where one can easily operate the present invention.

Another component shown is the drive system 33. This system is an AC or DC drive motor that turns or drives the rotisserie system 75 (not shown here) at a rate of approximately 1 to 2 RPM, more or less. Food is placed into the Cooking chamber 47 by means of the food access doors 32. Part of the key control is the airflow system in which the air ultimately flows out the exhaust stack 37. After the food is cooked, it may be removed from the smoker 31 and placed in an optional warming box 36.

FIG. 3 is a Perspective View of the Front and Drive End of the Present Invention with Details of components. Here the same drive system 33, exhaust stack 37 and warming box 36 are shown as described above. Additionally, the front food tray 38 is shown where the food is prepared and staged prior to entering and after cooked in the cooking chamber 47. This view also shows the optional Finishing Grill 39, the trailer trim 40 and the wheel spokes 41.

The Finishing Grill 39 is an optional feature where various sauces and other foods and spices may be added to the cooked and smoked foods after they have been through the present invention 31. The trailer options 40 permit diamond plate, stainless steel, aluminum and the like. The wheel spoke options 41 provide chrome, aluminum white or the like as an optional feature.

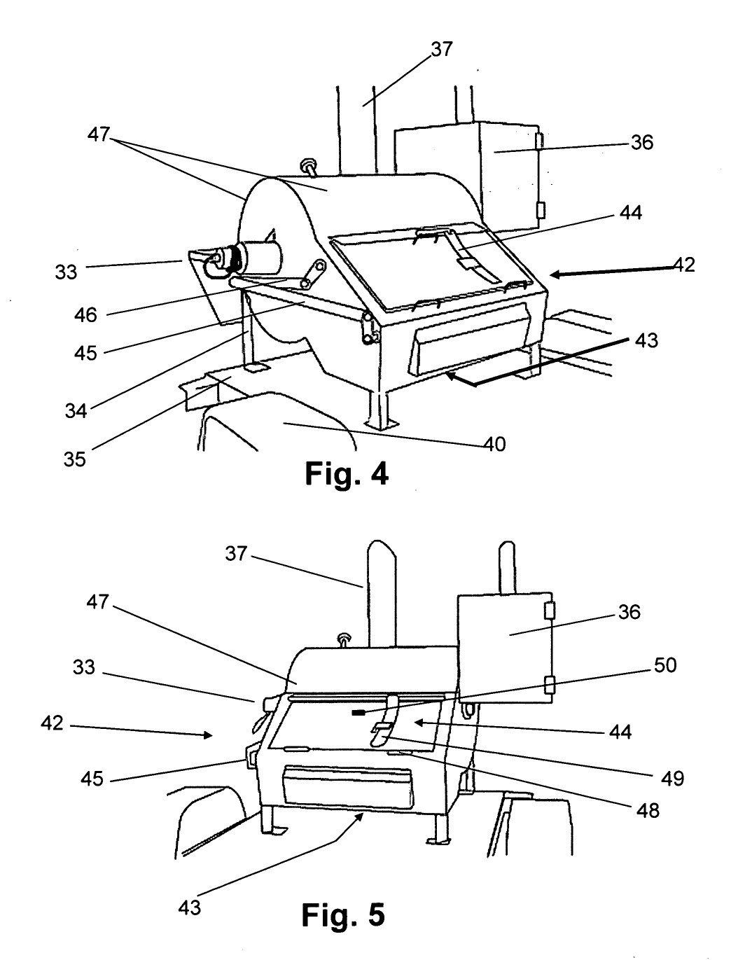

FIG. 4 is a Perspective View of the Back and Drive End of the Present Invention with component details. Here the previously described drive system 33, exhaust stack 37, support structure 34, trailer bed 35, the trailer trim 40, and warming box 39 are shown. Additionally, the important air and temperature control linkages 45 and 46 are shown. These linkages join the levers (58 and 59—not shown) on the front side to the air intake 76 and temperature 70 baffles described below.

The cooking chamber 47 is generally shown. On the backside, the firebox 42 generally is depicted. The firebox 42 is a separate section/chamber and runs laterally along the full expanse of the cooking chamber 47. Both the firebox and cooking chamber are comprised of 3/16 or 10 gage high quality steel or the like welded (or similarly sealed/fastened together) to contain the heat and by-product smoke from the fuel system.

The cooking chamber 47 is generally cylindrical in shape. The diameter may vary depending on the size (see the operation of the embodiment, below). The length of the chamber 47 may also be varied (see examples below). One skilled in the art appreciates the actual configuration of the chamber and firebox may be changed without disturbing the scope and spirit of the present invention.

All the linkages, handles, baffles, stacks and shelves are shown as steel. One skilled in the art appreciates this material may vary as long as the structural strength and the temperature capability is achieved. As new materials are developed, the scope and spirit of this invention may be applied easily to these new materials as well as other currently existing materials. For food preparation and an overall sanitary environment it is suggested that the front shelf 8, the rotisserie food trays 31 (shown and described below), and other components that may contact uncooked and cooked food be made of stainless steel or the like.

As part of the firebox 42 system, one notes that the air intake opening 43 and the latching/seal system 44. The intake of air is diverted down and below the fuel to enhance the fast start-up and efficient burning of the fuel. The latch 44 provides an air tight seal to the firebox 42 to prevent the escape of smoke or hot air to the atmosphere.

FIG. 5 is a Back View of the Present Invention with component details. The cooking chamber 47, the drive system 33, the firebox 42, the warming box 39, and the air intake 43 are shown as described above. Additionally, the air control linkage 45 and firebox latching seal 44 are shown.

Additionally, this view depicts the Firebox door/cover latch 49, the firebox pivot or hinge system 48 and the firebox door handle 50. These in total provide access to where the fuel is loaded to the firebox and the chamber is sealed from gas or heat escaping to the atmosphere.

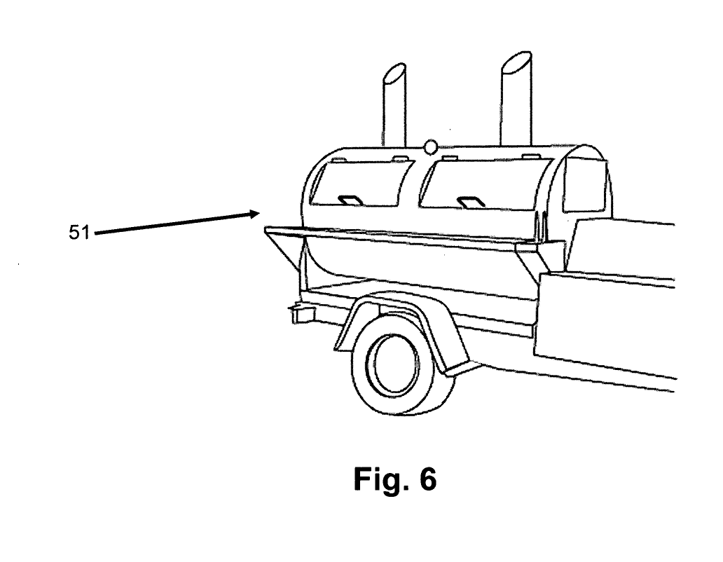

FIG. 6 is a Front Perspective View of a Six-Foot Smoker Unit. It shows generally a six (6) foot smoker unit 51.

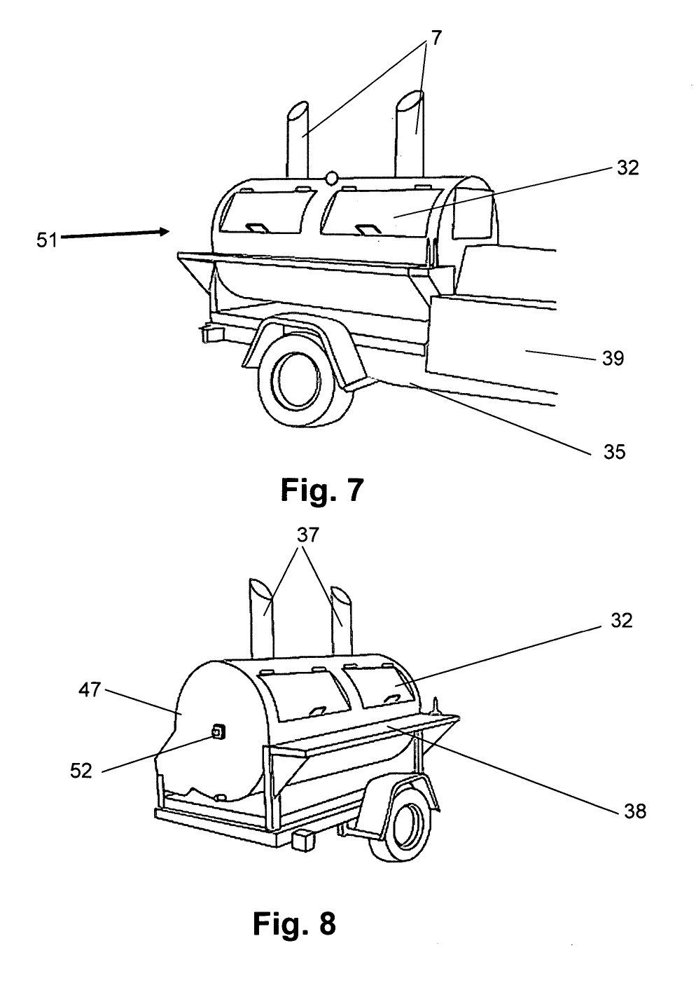

FIG. 7 is a Front Perspective View of a Smoker Unit with component details. It again shows the previously described Finishing Grill 39, the exhaust stack 37, the trailer 35 and the six (6) foot smoker 51. In addition it shows multiple food access doors 32. One notes that the number of access doors varies with the size of the unit and the need to access the rotisserie area.

FIG. 8 is a Front and Freely Driven Perspective View of a Six-Foot Smoker Unit with component details. It shows the previously described exhaust stack 37, the food access doors 32, the cooking chamber 47, and the front tray 38. Additionally, it shows the free-driven bearing system 52 on the driven end of the cooking chamber 47.

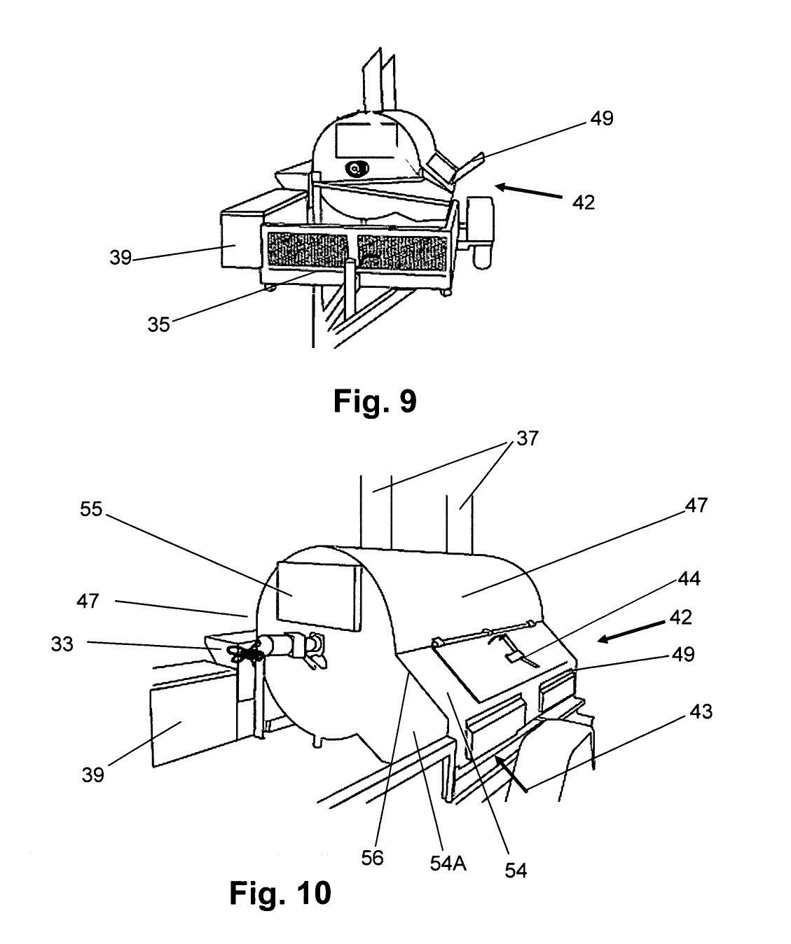

FIG. 9 is a Drive End View of a Smoker Unit with component details. It shows the previously described firebox 42 and the support trailer 35. In addition, this view depicts the open access door to the firebox 49 and the previously mentioned finishing grill 39. The access door is made of 3/16 inch, ¼ inch, 10 gage or equivalent high-grade steel (ASTM 36 or the like).

FIG. 10 is a Front and Drive End Perspective View of a Smoker Unit with component details. It shows the referenced high grade steel cooking chamber 47, similarly constructed firebox doors 49, the firebox latch system 44, the firebox generally 42, the air intake opening 43, the air and temperature linkages 46 and 45, and the drive system 33. Additionally shown are the welded/sealed joint 56 between the firebox 42 and the cooking chamber 47. Important too are the end plates and top plates of the firebox 54 and 54A. These are made of materials similar to the other parts of the firebox 42 and the cooking chamber 47.

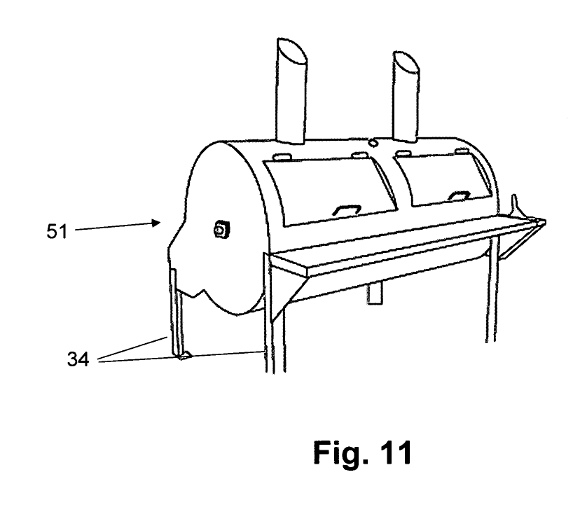

FIG. 11 is a Freestanding Front Perspective View of a Smoker Unit. Here a freestanding six-foot smoker 51 is shown on the support system 34.

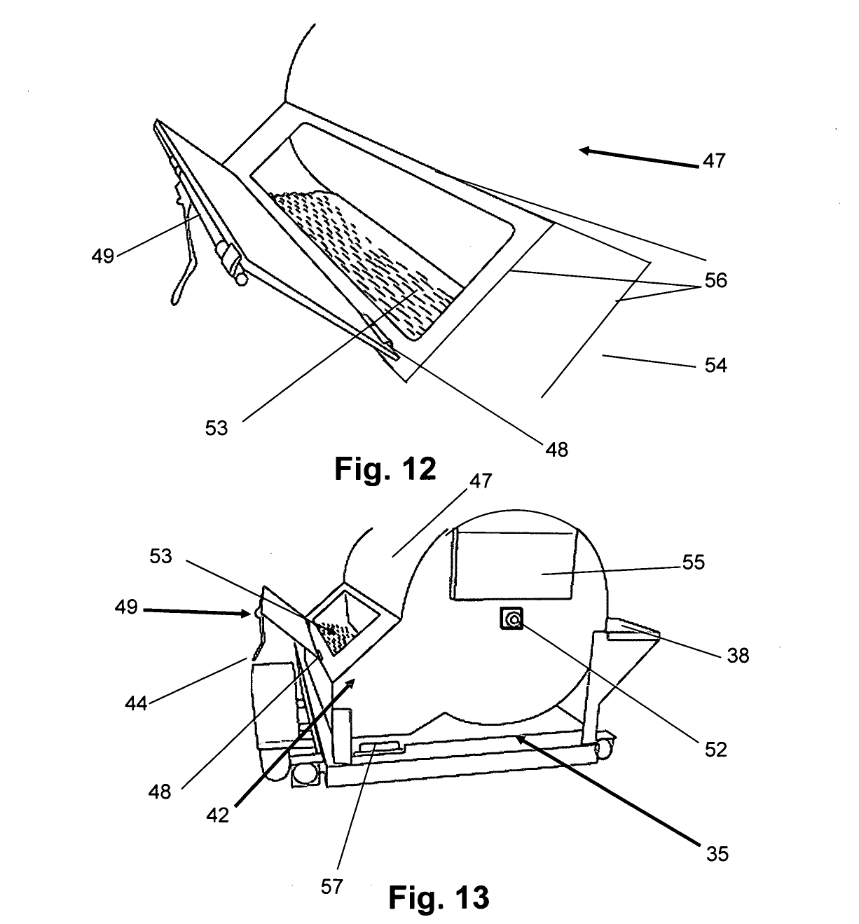

FIG. 12 is a Close Perspective View of a Firebox under construction with component details. Shown components include the previously described cooking chamber 47, the firebox 42, the welded/sealed connection 56 of the firebox 42 to the cooking chamber 47, and the firebox access doors 49. In addition shown are the firebox access door hinges and/or pivot system 48 and the fuel support system (grate) 53. Said fuel support system 53 is made of stainless steel, black iron or other steel or steel equivalents resistant to temperatures but with sufficient structural strength to support the fuel matter for the smoker. The material is an open “mesh” to permit air to reach the fuel for complete combustion.

FIG. 13 is a Freely Driven End Perspective View of a FIREBOX for a Smoker Unit with component details. Shown components include the previously described cooking chamber 47, the firebox generally 42, the firebox access doors 49, the Firebox fuel grate 53, the firebox door hinges 48, the firebox latch system 44, the front tray 38, the driven end bearing system 52, and the front tray 38.

Additionally shown are the special end plate 55 and the ashtray 57. The end plate 55 is separated from the high-temperature cooking chamber 47 and provides a support surface for written materials or control devices. The ashtray 57 extends the length of the firebox 42 and permits periodic removal of waste (ashes) from the fuel burning process. In addition, the end plate 55 provides a mounting surface for control devices or advertising/information material.

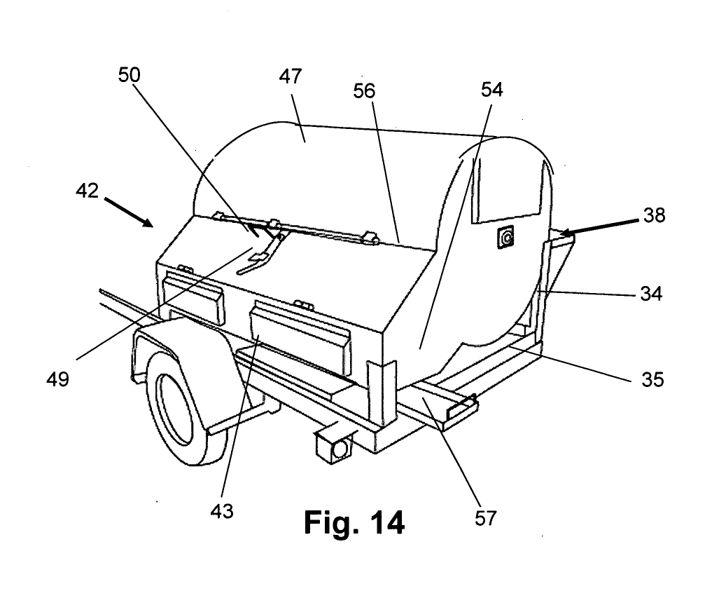

FIG. 14 is a Back Perspective View of a Firebox for a Smoker Unit with component details. Shown components include the previously described cooking chamber 47, the firebox access doors 49, the Firebox handle 50, the air intake aperture 43, the ashtray 57, the trailer 35, the support system 34, the front tray 38, the weld seam 56 and the top of the firebox 54.

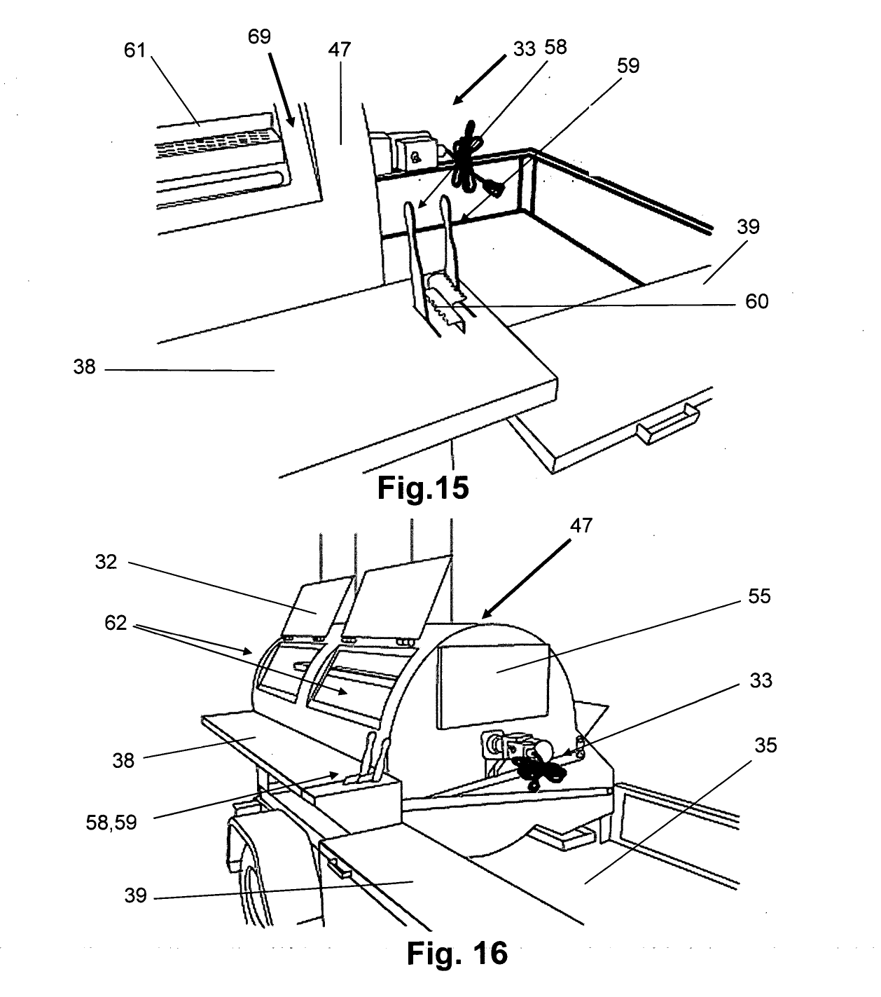

FIG. 15 is a Close View of the Baffle Adjustment Levers on the Front Side of a Smoker Unit with component details. Shown components include the previously described cooking chamber 47, the drive system 33, the finishing grill 39, and the front tray 38. In addition, this close view shows the air intake baffle control lever 59 and the temperature control lever 58. These levers are directly linked to the baffles in the firebox 42 and provide easy functional adjustments to the air into the firebox 42 and the heat/temperature into the cooking chamber 47.

Additionally shown is a means 60 to control the settings for the previously mentioned levers 58 and 59. Further, the food tray 61, which is interior to the cooking chamber 47 and part of the rotisserie 75, is shown. This is comprised of several components to prevent tray sticking/tipping that are described below. Next, an intricate labyrinth 69 of the sheet metal exterior to the cooking chamber is shown. This configuration portrays a system that contains the heat and smoke via a series of ninety-degree turns in the sheet metal configuration.

FIG. 16 is a Drive End Perspective View of the Baffle Adjustment Linkage System for a Smoker Unit. Shown components include the previously described cooking chamber 47, the drive system 33, the finishing grill 39, and the front tray 38. In addition, this close view shows the temperature and air control levers 58 and 59, the trailer support 35, the end plate 55 and the food access covers 32. Further this view demonstrates the food door aperture 62 where the various foods are loaded onto the rotisserie system 75.

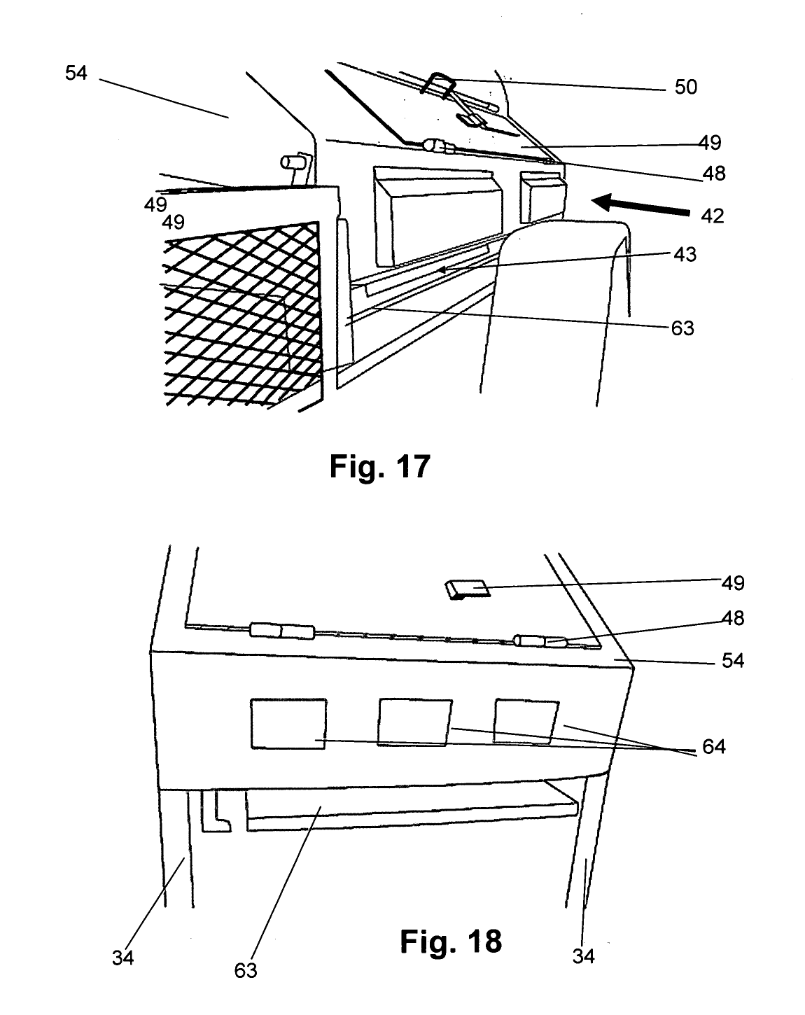

FIG. 17 is a Close View of the Back Side Air Intake Cover and Air Diverting System. This view shows the previously mentioned Top of the firebox 54, the firebox handle 50, the firebox cover 49 and the firebox hinge/pivot 48. Additionally shown are the fireboxes in general 42, the air intake aperture 43 and the air intake diverter 53. This view demonstrates the overall configuration of the present invention.

FIG. 18 is a Back View of a Smoker and Firebox under construction. This view shows the previously mentioned Top of the firebox 54, the firebox handle 50, the firebox cover 49 and the firebox hinge/pivot 48. In addition, this view portrays the air intake openings 64 into the firebox, the air diverter 63 and the structural supports 34.

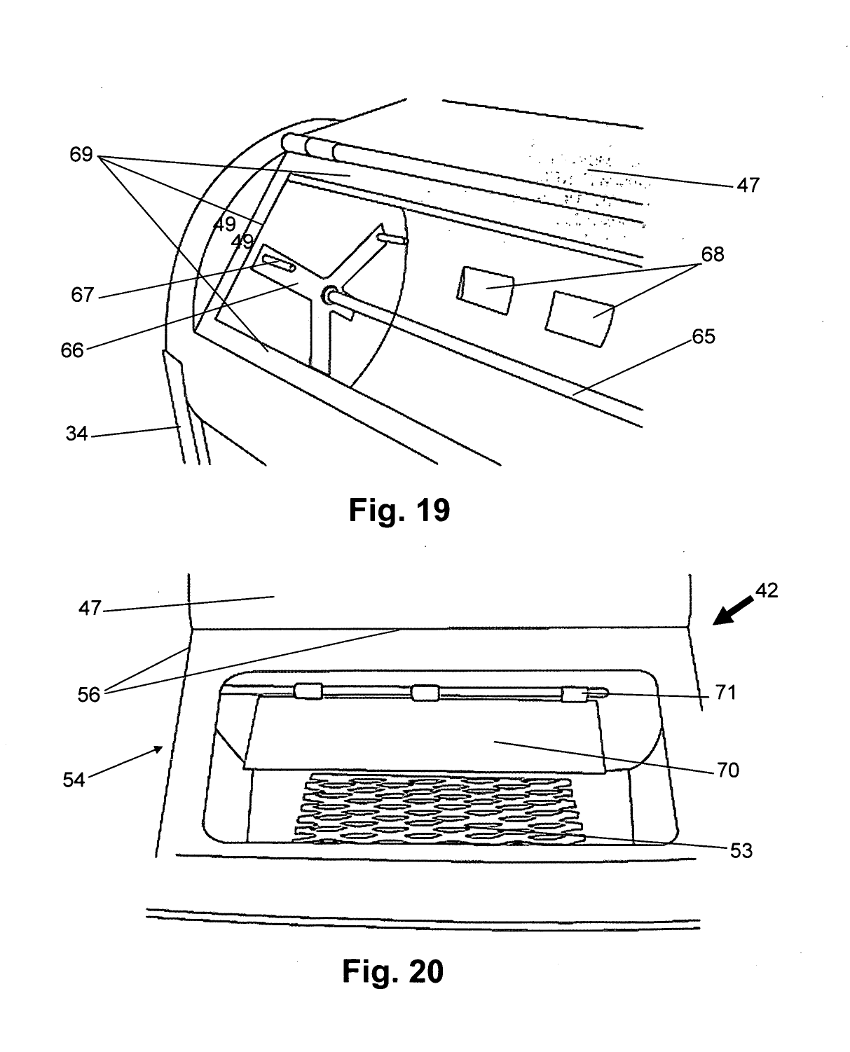

FIG. 19 is a Front View of a Smoker and Cooking Chamber under construction. This view shows the previously mentioned Cooking Chamber 47, front door seal configuration 69, and structural support 34. Additionally, the rotisserie shaft/drive mechanism 65, the rotisserie system pivot/mount system 67, the support structure 66, and the openings from the fire box to the cooking chamber 68 are shown.

FIG. 20 is a Close View of a Back of a Smoker Firebox under construction. This view shows the previously mentioned Cooking Chamber 47, the seal 56 between the firebox 42 and the cooking chamber 47. The top of the firebox 54 and the fuel grate temperature baffle 70 are shown. The temperature baffle 70 is controlled to prevent ember invasion into the cooking chamber 47 and to control the temperature of the cooking chamber 47. In addition are shown the pivot system 71 for the temperature control baffle.

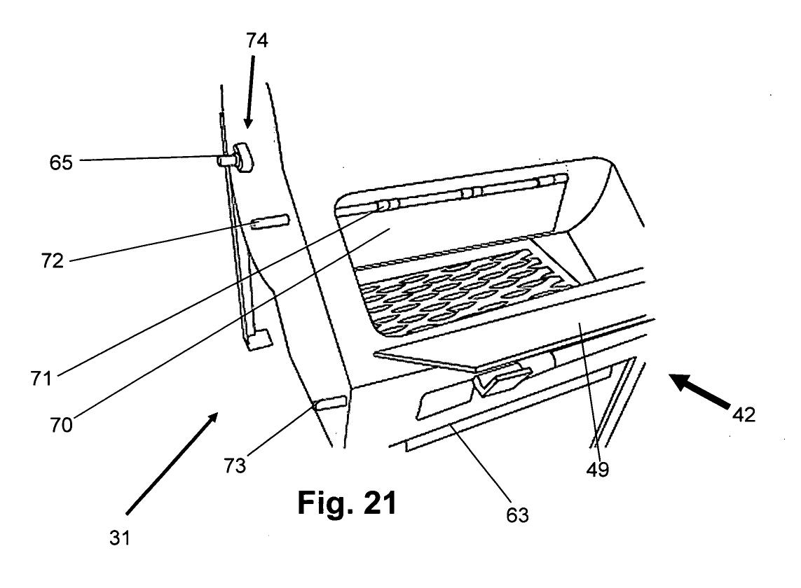

FIG. 21 is a Back Perspective View of a Smoker Firebox under construction. This view shows the end of the Main Rotisserie shaft 65; the temperature control shaft 72 connected to the baffle 70 and pivot 71; the air intake shaft extension 73; the air diverter 63; the firebox cover 32; and the firebox 42 in general. One notes that the extension area of the shaft 65 shown here is where the drive system 33 (not shown) is coupled and mounted to the device.

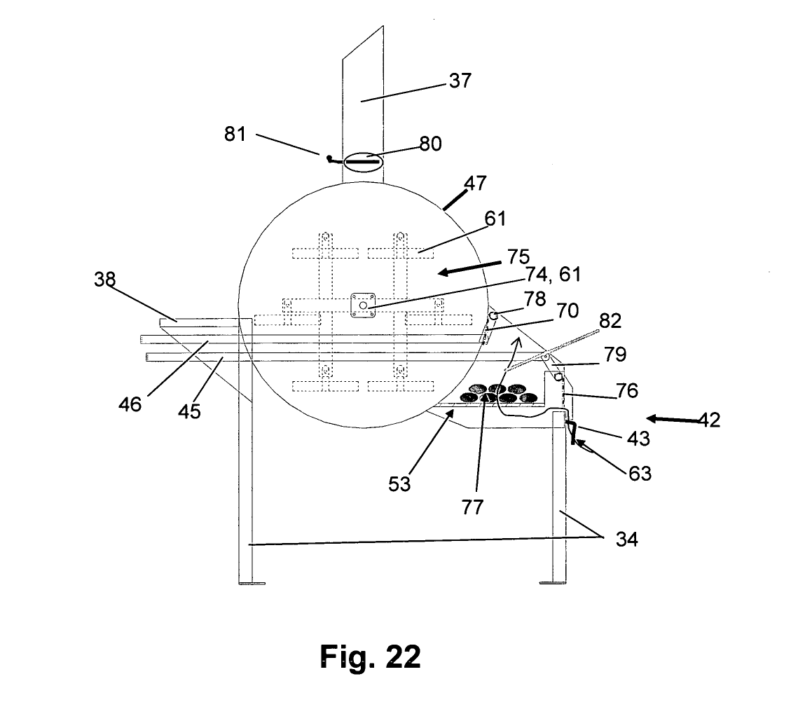

FIG. 22 is a Cross-section Drawing of a Smoker with the Air Diverting System “Closed-off”. In this drawing one may note that the airflow 82 enters the firebox 42 through the aperture 43. It is diverted by means of the air diverter 63 along the length of the firebox 42. The airflow 82 is restricted by means of the airflow baffle 76 being in the “fully closed” position. The air is directed under the fuel grate 53 and then up through the fuel 77. The Temperature baffle 70 is also in a closed position. This closure of the temperature baffle 70 also restricts most of the air and heat to then flow out the top of the firebox 42. This restriction continues to restrict air to the fuel 77.

One notes that the air baffle 76 is controlled from the front side where the food tray 38 is located. The control is through a control means such as a linkage 45 and 79 or the like. Similarly, the temperature baffle 70 is controlled from the front side where the food tray 38 is located. The temperature control is through a control means such as a linkage 46 and 78 or the like. The main exhaust stack(s) 37 is shown in a closed position. This stack is controlled by a control mechanism 81 which is a lever, handle or the like. The mechanism 81 is linked to the stack baffle 80 to restrict or to permit airflow.

To enable one to easily understand the airflow in this FIG. 22 and the following FIGS. 53 and 54 other reference components are detailed. The main cooking chamber 47 contains the rotisserie 75. This system for holding the food is comprised of individual food tray 61, various structural linkages and a main bearing system and shaft 74, 65.

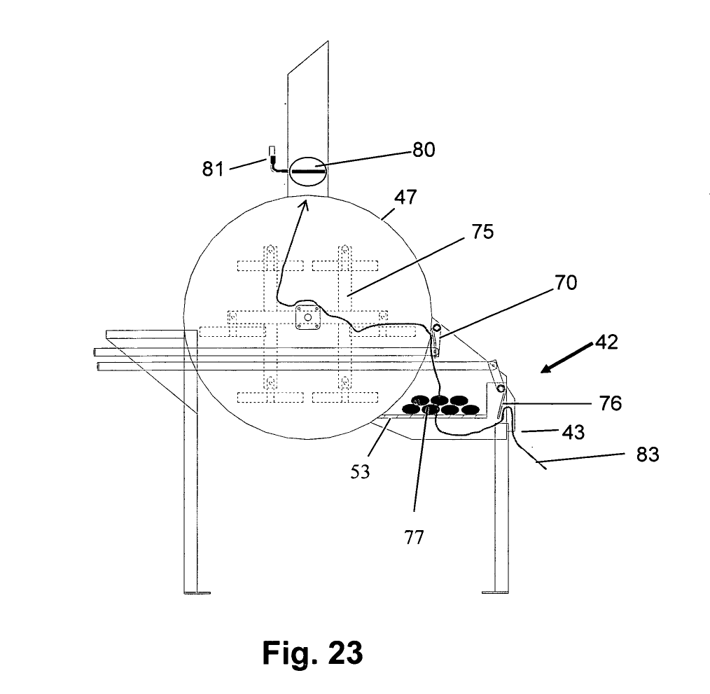

FIG. 23 is a Cross-section drawing of a Smoker with the Air Diverting System “Opened Partly”. In this drawing one importantly notes that the airflow 83 enters the firebox 42 through the aperture 43. The airflow 83 is partially restricted by means of the airflow baffle 76 being in the “opened partly” position. The air is directed under the fuel grate 53 and then up through the fuel 77. The Temperature baffle 70 is also in a partly opened position. This opening of the temperature baffle 70 permits most of the air and part of the heat to then flow into the cooking chamber 47. The air continues to rise through the chamber 47 and finally past the partly opened exhaust baffle 80 and out the exhaust stack 37. One skilled in the art fully appreciates the multiple placement and possible positions for all three of the baffles 76, 70 and 80. Through the adjustment of these said baffles, the draft is fully and consistently controlled.

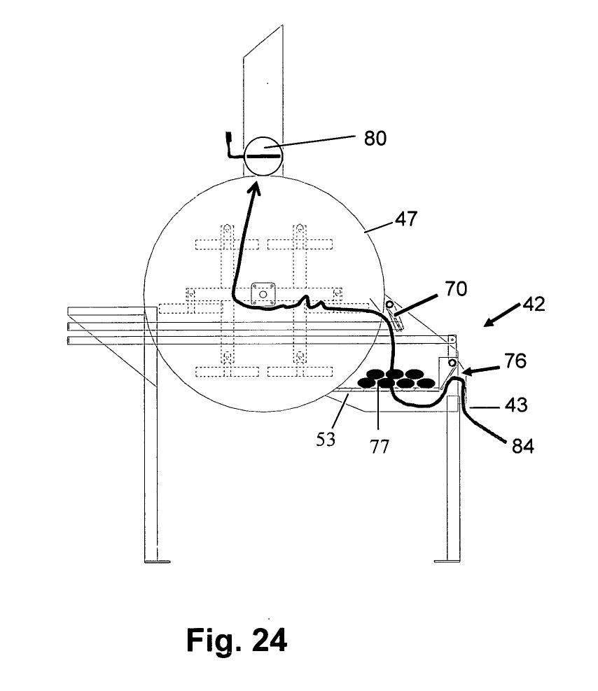

FIG. 24 is a Cross-section drawing of a Smoker with the Air Diverting System “Opened full”. In this drawing one may note that the airflow 84 enters the firebox 42 through the aperture 43. The airflow 84 is unrestricted by means of the airflow baffle 76 being in the “fully opened” position. The air is directed under the fuel grate 53 and then up through the fuel 77. The Temperature baffle 70 is also in a fully opened position. This opening of the temperature baffle 70 permits almost all of the air and most of the heat to then flow into the cooking chamber 47. The air continues to rise through the chamber 47 and finally past the partly opened exhaust baffle 80 and out the exhaust stack 37. One skilled in the art still appreciates the multiple placement and possible positions for all three of the baffles 76, 70 and 80. Through the adjustment of these said baffles, the draft is fully and consistently controlled.

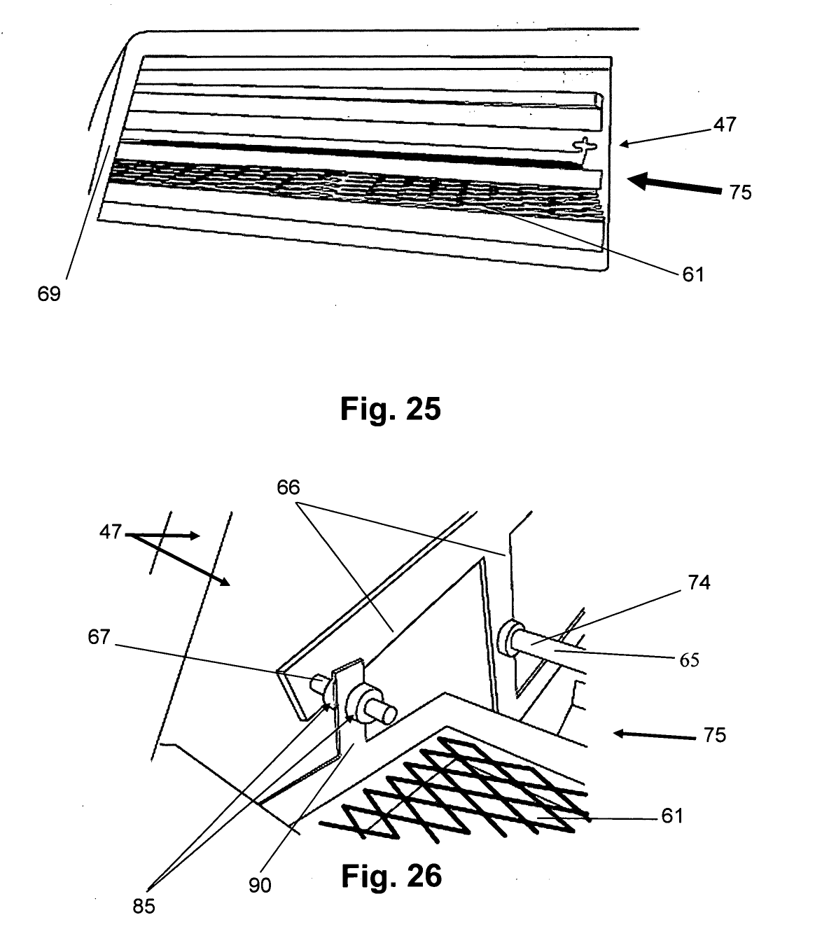

FIG. 25 is a Front View of a Smoker Unit under construction showing the Food Holding Tray 61 and Rotisserie System 75 in the Cooking Chamber 47. Here one notes that the cooking chamber 47 has a recessed area 69 for the food door cover 32 (not shown). This recessed area permits a “flat” cover 32 to fit tightly to the curved cooking chamber 47. The “labyrinth-like” seal between the recessed area 69 and the doors 32 prevent the escape of heat and smoke to the atmosphere. This aids in an economical retention of heat as well as safely keeping heat and smoke from the cook/operator. The recessed area 69 also creates a diversion of the heat and smoke when the cover 32 is opened to add or remove the food from the food tray 61 of the rotisserie 75.

FIG. 26 is a Close View of the Food Tray Mounting and Pivot System. Here the food tray 61 of the general rotisserie system is connected to the cooking chamber 47. Recall that on the exterior of the cooking chamber 47 a drive system 33 (not shown in this view) is attached. The said drive 33 is coupled to the main shaft 65 through a bearing 74 and collet 85. The collet 85 is fixed to the food tray spreader means 66 (such as flat steel bars or the like) by a means of fastening such as welding, keying, set screws, or the like. The collet 85 is also fastened in a fixed position to the shaft 65 by means of keying, set screws or the like.

The spreader bars 66 are positioned to hold the multiple food trays 61 in a fixed relation to each of the other food trays 61 (see FIG. 25). One skilled in the art of rotisseries appreciates that the relational position depends on the number of trays. Normally there may be 2, 3, 4, 6, or 8 trays (or the like) depending on the chamber 47 diameter. The angular relation of the trays is simply determined by equally spacing the trays around the 360 degree circumference. Likewise the number and relation of the spreader bars 66 provide the fixed relation of the trays 61 and the connection back to the shaft 65 and ultimately to the rotisserie drive 33.

At the end of the spreader bars 66 is a fixed pivot shaft 67. This cantilevered stub shaft 67 is fastened in a fixed position to the spreader bar 66 by means welding, bolting, or other fastening means. A “no-tip” feature is provided by the use of two collets 85 fixed to the shaft by a key, set screw or the like. Theses said collets 85 are placed on either side of the tray strap 90. This strap is then directly connected to each food tray 61 by welding or other fastening means. Also, one notes that the said tray strap 90 has an aperture to loosely slip fit over the stub shaft and provide the “no tip” feature during the turning of the rotisserie 75.

The materials used for all these said members can vary as one skilled in the art appreciates. The strap 90 spreader bars and shaft are shown as steel or the like. The material must be strong and temperature resistant. The food trays 61 can also be of steel or the like. For easy clean up and sanitary conditions, stainless steel mesh has worked well. The open mesh permits the food to get even heat from all sides in the chamber 47. Finally the bearing 74 is shown as a high temperature ball bearing. One skilled in the art appreciates other various systems and materials might be use. For example a high temperature bushing system, a needle or thrust bearing system, or other means to hold the shaft 65 while being turned by the drive 33.

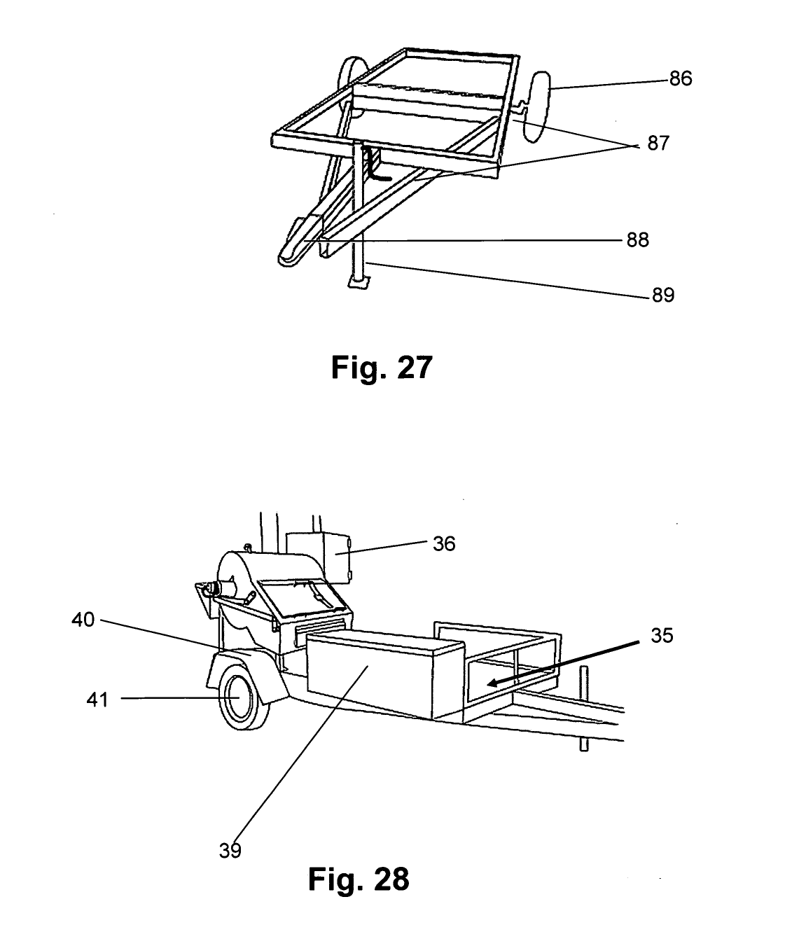

FIG. 27 is a View of the Trailer Structure under construction. It includes the wheel system 86 connected to the general structural support 87. The support has a front vertical support “jack” 89 and a means to attach to a vehicle 88 such a hitch or the like.

FIG. 28 is a View of a Side View of a Smoker Unit on a Trailer with several of the Optional Features for a Smoker System. In this view, the warming box 36 and the finishing grill 39 are mounted on a trailer 35. The trailer has options for various trim packages 40 (see description below) and wheel packages 41 (also described below).

In total all the points and details mentioned here throughout this detailed description of the drawings are exemplary and not limiting. For example, one skilled in the art appreciates the plethora of fastening devices and systems that could be utilized in the present invention. The weldments and other fastening systems shown are exemplary and not limiting to the fastening system of this invention. Other components specific to describing an Improved and Transportable Cooking and Smoking Barbeque Apparatus often called a Smoker may be added as a person having ordinary skill in the field of this invention well appreciates. The drawings and components have been focused on the parts shown in respect to the present invention.

### Operation of the Preferred Embodiment

The Improved and Transportable Cooking and Smoking Barbeque Apparatus often called a Smoker as the present invention has been described in the above embodiment. The manner of how the invention operates is described below. The description above and the operation described here must be taken together to fully illustrate the concept of the present invention.

The embodiment described above is an improved Smoker device, generally, 31. The preferred embodiment is a Smoker device in various sizes mounted on a portable trailer bed 35. An alternative embodiment uses the scope of the improvements but may be utilized as a freestanding, non-portable device to attain the improvements without the cost of the trailer system. Both the portable and freestanding devices are vertically supported by means of a support system 34 from the stationary ground or trailer bed.

Both embodiments have standard features comprised as shown in TABLE A:

TABLE A
Standard Features

| Item | Standard Features |
|---|---|
| 1 | Cooker and Firebox manufactured with “certified” |
| | American steel |
| 2 | 25 year burn-through warranty on cooking chamber |
| 3 | Large doors for easy access |
| 4 | Direct drive motor |
| 5 | Firebox with easy to use air control dampers. Heats up |
| | quickly, warranted for life. |
| 6 | Door design helps keep heat and smoke in the cooking |
| | chamber when opened. |
| 7 | Unique sliding plates for easy ash clean out. |
| 8 | Rotating racks provide excellent smoked flavor without |
| | flipping and constant supervision of the meat. |
| 9 | All trailer-mounted units are ready for titles. |
| 10 | Tandem trailers with 2 axle brakes. |
| 11 | Trailers come with your choice of hitch size, 2″ or |
| | 2 5/16″ |
| 12 | Smokers with trailers have all lights wired and tested. |
| 13 | Electric brakes wired, tested, and adjusted. |
| 14 | Hydraulic brakes if equipped are tested and adjusted. |
| 15 | All trailers with 2 axles or more will be fitted with |
| | breaks, breakaway switches, cables, safety chains, and |
| | jack. |
| 16 | American Pride Smokers have a unique damper system on |
| | both the draft and cooking |
| | chamber damper to ensure better control of heat and |
| | smoke than our competitors. |
| 17 | Large 3″, easy to read, thermometer. |
| 18 | Burns charcoal or hardwood. |
| 19 | Hand welded and heavy construction materials for |
| | durability. |
| 20 | American made, from start to finish. |
| 21 | Red trailer is standard. |

Key to the operation of the new devices is a firebox 42 that runs laterally along the full side of the cooking chamber 47. The air intake is through the aperture 43 and around the air diverter 63. The path of the airflow 82, 83, and 84 is directed through the fuel support grate 53 and the fuel 77. The quantity of air (draft) is determined primarily by the openings of the air baffle 76 and the temperature baffle 70. The “fine tuning” of the temperature is by means of the opening of the exhaust stack baffle 80. All baffles are controlled by their respective control levers/handles 59, 58, and 81.

The operation of the Smoker device 31 parallels other smokers. The fuel 77 is placed on the grate 53. Then the baffles 59, 58, and 81 are opened to provide airflow 82, 83, and 84. Finally, the fuel is lit directly or lit through some assist means such as an LP gas lighter (not shown). The baffles 59, 58, and 81 further control the airflow 82, 83, and 84.

Once the Smoker Unit 31 has achieved the proper temperature in the cooking chamber 47 (as shown by an optional thermometer gage—not shown), the food is loaded into the chamber 47 normally from the front shelf tray 38 in front of the chamber 47. The food doors 32 are opened and the food (meats, fish, vegetables and fruit) are placed on the rotisserie system 75—specifically on the individual trays 61.

When the food has been cooked, it is removed from the tray 61 and placed into the warming box 36 or finishing grill 39. Once placed on the finishing grill 39, additional sauces or food and spices may be added to the food prior to serving.

As the Smoker unit 31 is continually used, additional fuel 77 is placed on the grate 53. Periodically, the ashtray 57 is pulled from the smoker unit 31 and emptied. At the end of the cooking session, the fuel 77 is removed from the grate and lightly doused with water or permitted to “burn out”. Then the remaining ashes are removed from the ashtray 57.

Operation of the portable 31 and freestanding 51 devices are the same. The portable device may be moved from the area of cooking, whereas the freestanding device is more “permanent”. There are currently several sizes of the Smoker designed and available. The following TABLE B is exemplary and not limiting of the use of the present invention.

TABLE B
Examples of Smoker Sizes
Examples of Smoker Sizes

| | | Diameter | Cooking | | |
|---|---|---|---|---|---|
| | Approximate | Cooking | Chamber | Firebox | |
| Item | Length | Chamber | Gage | Gage | Food Trays |
| 1 | 2 Feet | 28 inch | 10 ga | 10 ga | 3 |
| 2 | 3 Feet | 30 inch | 3/16 in. | ¼ in. | 3 |
| 3 | 4 Feet | 38 inch | 3/16 in. | ¼ in. | 2, 4 or 6 |
| 4 | 6 Feet | 38 inch | 3/16 in. | ¼ in. | 2, 4 or 6 |
| 5 | 8 Feet | 38 inch | 3/16 in. | ¼ in. | 2, 4 or 6 |
| 6 | 10 Feet | 38 inch | 3/16 in. | ¼ in. | 2, 4 or 6 |
| 7 | 12 Feet | 38 inch | 3/16 in. | ¼ in. | 2, 4 or 6 |
| 8 | Other By | To | To suit | To | To suit |
| | Request | suit | | suit | |

There are several alternative embodiments or options available for the present smoker device 31 as shown here in TABLE C:

TABLE C
Example of Alternative/Optional Features
Example of Alternative/Optional Features

| Item | Feature |
|---|---|
| 1 | Finishing grill - for applying sauces |
| 2 | Griddles for finishing grill. |
| 3 | Beer Keg Cooler. |
| 4 | Warming box (choice of direct fired or |
| | charcoal) |
| 5 | Water can be used for moist heat |
| 6 | Hog roasting cage |
| 7 | Deep fryer - to cook a turkey, French |
| | fries, and etc. |
| 8 | Sink with hot & cold water. |
| 9 | Wood storage box. |
| 10 | Trim options: diamond plate, stainless |
| | steel, or bright aluminum tread plate |
| 11 | Spoke Options: Chrome, aluminum, or white |
| 12 | LP log lighter (hose & regulator not |
| | included) |
| 13 | Pull out ash pan on trailer models |
| 14 | Mounted spare tire |
| 15 | Water storage up to 100 gallons, space |
| | permitting |
| 16 | Waste water storage up to 100 gallons, |
| | space permitting. |
| 17 | Custom paint. |
| 18 | Water steam pan. |
| 19 | 2″ warming box thermometer. |
| 20 | Special hitch to allow you to secure your |
| | smoker to your hitch receiver (home models |
| | only!). |
| 21 | Dual motors on any smoker (all smokers 8 - |
| | 12 feet long have dual as standard |
| 22 | Length up to 12 feet. |
| 23 | All smokers 6′ and larger can be built |
| | with a single access door for using the |
| | optional whole hog rotisserie cage. Unique |
| | to American Pride Smokers. |
| 24 | Spring ride or torsion ride axles up to |
| | 7000 pd. capacity each. |
| 25 | Power front jack, when plugged into |
| | vehicle. |
| 26 | 4 corner leveling jacks, manual or |
| | electric. |

One well skilled in the art of barbeque smokers appreciates that burn rate, temperature, and the draft are controlled by air baffle levers 59, 58, and 81. In addition to the individual smokers, it is readily understood that these devices, especially the larger versions, may well be used for restaurant, concession and catering services.

The Improved and Transportable Cooking and Smoking Barbeque Apparatus invention has been described above in connection with what is presently considered to be the most practical and preferred embodiment. An alternative embodiment that may be used with a standard connector has also been described. With these descriptions it is to be understood that the invention is not to be limited to the disclosed embodiment. On the contrary, the invention is intended to cover various modifications and equivalent arrangements included within the spirit and scope of the description.

1. A transportable barbeque apparatus for cooking and smoking various meats, fish, vegetables, fruits and other foods comprising:
(a) a metal firebox configured to contain a supply of combustibles which produce smoke and heat upon burning for purposes of cooking and smoke processing foods;
(b) a metal cooking and smoking chamber horizontally mounted and laterally contiguous to the firebox;
(c) a means to support the food interior to the cooking and smoking chamber
(d) a means to control the heat and smoke;
(e) a means to support the cooking chamber and the firebox; and
(f) a means to integrally fasten together the firebox, the chamber, the firebox and chamber supports, the food
support and the heat and smoke controls whereby heat and smoke produced within the firebox are directed into cooking and smoking chamber for processing the foods contained therein and whereby heat and smoke are then exhausted from the chamber.

2. The device according to claim 1 wherein the firebox is configured longitudinally and parallel to the ground.

3. The device according to claim 1 wherein the firebox has apertures for the air intake with the apertures partially covered by a metal sheet whereby the sheet and apertures are configured to create part of a special labyrinth which aids the control of the air flow.

4. The device according to claim 3 wherein the means to control the heat and smoke is comprised of an air baffle which runs longitudinally in the firebox and completes the special labyrinth; a temperature and heat baffle which runs longitudinally in the firebox and contiguous to the cooking chamber; and an exhaust system which removes the heat and smoke from the cooking chamber whereby a fast start-up of the combustible is achieved and the time to achieve the desired cooking and smoking temperature in the chamber is minimized and whereby this means to control the heat and smoke provides a superior control over heat and air when compared to prior art smokers and cookers.

5. The device according to claim 4 wherein the exhaust system is at least one vertical stack with an adjustable baffle whereby the baffle is moved to help control the temperature in the cooking chamber.

6. The device according to claim 1 wherein the means to support the food is a plurality of trays movably connected to a rotisserie system whereby the food is continuously rotated and exposed to the varying heat and smoke in the chamber.

7. The device according to claim 6 wherein the connection of the trays to the rotisserie system is by means of precision collets whereby an “anti-tipping” feature is provided that is superior when compared to prior art rotisserie systems.

8. The device according to claim 6 wherein the rotisserie system is moved by means of an electric drive system whereby the rotational movement of the system may be variably controlled and is a smooth movement.

9. The device according to claim 8 wherein the electric means may be driven by both alternating current and by direct current.

10. The device according to claim 1 wherein the metal cooking and smoking chamber is further comprised of metal end plates fastened to a rolled metal barrel, an aperture in the barrel connected to the to the firebox, and at least one access aperture covered by a moveable door.

11. The device according to claim 10 wherein the aperture in the barrel and the access door form a sealing labyrinth whereby the containment of the heat and smoke is superior when compared to prior art smoker devices.

12. The device according to claim 10 wherein the aperture and access door further has a front tray for supporting food during the loading and unloading of the food.

13. The device according to claim 1 wherein the means to support the cooking chamber and the firebox is a multiple leg system.

14. The device according to claim 1 wherein the means to support the cooking chamber and the firebox is supported by a utility trailer.

15. The device according to claim 1 wherein the means to support the cooking chamber and the firebox is integral to a concession trailer whereby the device may be part of a larger food preparation system which is easily transportable.

16. A transportable barbeque apparatus for cooking and smoking various meats, fish, vegetables, fruits and other foods comprising:
(a) a metal firebox configured to contain a supply of combustibles which produce smoke and heat upon burning for purposes of cooking and smoke processing foods
wherein the firebox is configured longitudinally and parallel to the ground and wherein the firebox has apertures for the air intake with the apertures partially covered by a metal sheet;
(b) a metal cooking and smoking chamber horizontally mounted and laterally contiguous to the firebox wherein
(c) a means to support the food interior to the cooking and smoking chamber
(d) a means to control the heat and smoke wherein the means is comprised of
1. an air baffle which runs longitudinally in the firebox and completes the special labyrinth;
2. a temperature and heat baffle which runs longitudinally in the firebox and contiguous to the cooking chamber; and
an exhaust system which removes the heat and smoke from the cooking chamber wherein the exhaust system is at least one vertical stack with an adjustable baffle
whereby a fast start-up of the combustible is achieved and the time to achieve the desired cooking and smoking temperature in the chamber is minimized and whereby this means to control the heat and smoke provides a superior control over heat and air when compared to prior art smokers and cookers;
(e) a means to support the cooking chamber and the firebox; and
(f) a means to integrally fasten together the firebox, the chamber, the firebox and chamber supports, the food support and the heat and smoke controls
whereby heat and smoke produced within the firebox are directed into cooking and smoking chamber for processing the foods contained therein and whereby heat and smoke are then exhausted from the chamber.
